(19) United States
(12) Patent Application Publication
(10) Pub. No.: US 2006/0268378 A1
(43) Pub. Date: Nov. 30, 2006

(54) Image signal processing circuit, display apparatus, and image signal processing method

(75) Inventor: Osamu Yano, Kagoshima (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; PIONEER PLASMA DISPLAY CORPORATION

(21) Appl. No.: 11/432,352

(22) Filed: May 12, 2006

(30) Foreign Application Priority Data
May 13, 2005 (JP) 2005-141675

(51) Int. Cl. G03F 3/08; G06K 15/00

(52) U.S. Cl. 358/521; 358/518; 358/3.27

(57) ABSTRACT

A display apparatus is provided with a reverse gamma conversion circuit, an image signal processing circuit, and a display device. The display device is a PDP in which the light-emitting characteristics are linear. The image signal processing circuit is provided with a smoothing signal generator for smoothing image signals after reverse gamma conversion. Also provided is a detector whereby patterns that are to be processed as signals are detected from the image. The patterns include points of variation in which the gradation difference prior to reverse gamma conversion is a single gradation and in which the gradation difference is made to be two gradations or more due to reverse gamma conversion. A substitution unit is provided for substituting the smoothed gradation values in place of a portion of the gradation values of the pattern, and outputting the result to the display device.

### BACKGROUND OF THE INVENTION

1. Field of the Invention

The present invention relates to an image signal processing circuit mounted in a display apparatus provided with a converter circuit, to a display device mounted therewith, and to an image signal processing method.

2. Description of the Related Art

Image signals distributed via broadcasting or the like are subjected to gamma conversion in accordance with the characteristics of a cathode-ray tube. In a display apparatus provided with a display device having the linear light-emitting characteristics of a PDP (Plasma Display Panel) or the like, reverse gamma conversion is required in order to offset the gamma conversion performed on the distributed image signal (refer to Japanese Laid-Open Patent Application No. 2001-320581, for example).

However, the prior art described above has problems such as those described below. FIG. 1A is a graph showing variation in an 8-bit gradation value before and after reverse gamma conversion, wherein the horizontal axis is the gradation value of an image signal prior to reverse gamma conversion, and the vertical axis is the gradation value of the image signal after reverse gamma conversion; and FIG. 1B is an enlarged view showing the area 100 on the high gradation side of FIG. 1A. The slope of the curve showing the variation of the gradation value before and after reverse gamma conversion is slight on the low-gradation side (dark side) and is considerable on the high gradation side (bright side), as shown in FIG. 1A. For this reason, when the gradation prior to conversion varies by a single gradation from 253 to 254, for example, the gradation after conversion varies by two gradations from 250 to 252, as shown in FIG. 1B. The gradation 251 is therefore unused in gradation after conversion.

Thus, when the gradation prior to conversion varies by a single gradation on the high-gradation side in reverse gamma conversion, the gradation after conversion varies by two or three gradations. Therefore, a PDP or another display device with linear light-emitting characteristics has excessive resolution with respect to the input value in the bright area. Conventionally, excessive resolution in the bright area is gradation that is not required and remains unused. Therefore, the gradation performance of the display device cannot be adequately demonstrated.

Moreover, if smoothing is performed, for example, by the method cited in Japanese Laid-Open Patent Application No. 2001-320581 after reverse gamma conversion, the entire image will be smoothed. For this reason, detailed patterns that represent intermediate gradation areas, dark areas, character information, and the like of the image are also smoothed, and the perceived resolution inherent in the image is compromised.

### SUMMARY OF THE INVENTION

The image signal processing circuit of a display device according to the first aspect (claim 1) of the present invention has a converter circuit for converting inputted image signals and a display device for displaying an image, the image signal processing circuit further comprising a smoothing signal generator to which the converted image signals are input and which smoothes the image signal along at least one direction of the image; a detector for detecting patterns from the image so that a pattern in which the gradation value of a plurality of pixels selected from a plurality of pixels constituting the display device and arrayed in a continuous fashion in the smoothing direction is a first gradation value, the gradation value of another plurality of pixels adjacent to the plurality of pixels on the smoothing direction side and arrayed in a continuous fashion in this direction is a second gradation value, the absolute value of the difference between a first pre-conversion gradation value corresponding to the first gradation value and a second pre-conversion gradation value corresponding to the second gradation value in the pre-conversion image signal is 1, and the absolute value of the difference between the first gradation value and the second gradation value is equal to or greater than 2; and a substitution unit for substituting the smoothed gradation value in place of the gradation value of at least one pixel selected from the pixels constituting the pattern, and outputting the result to the display device.

The display apparatus of the second aspect (claim 10) of the present invention has a converter circuit for converting inputted image signals, an image signal processing circuit for processing the converted image signals, and a display device for displaying an image on the basis of an image signal input from the image signal processing circuit, wherein the image signal processing circuit has a smoothing signal generator to which the converted image signals are input and which smoothes the image signal along at least one direction of the image; a detector for detecting patterns from the image so that a pattern in which the gradation value of a plurality of pixels selected from a plurality of pixels constituting the display device and arrayed in a continuous fashion in the smoothing direction is a first gradation value, the gradation value of another plurality of pixels adjacent to the plurality of pixels on the smoothing direction side and arrayed in a continuous fashion in this direction is a second gradation value, the absolute value of the difference between a first pre-conversion gradation value corresponding to the first gradation value and the second pre-conversion gradation value corresponding to the second gradation value in the pre-conversion image signal is 1, and the absolute value of the difference between the first gradation value and the second gradation value is equal to or greater than 2; and a substitution unit for substituting the smoothed gradation value in place of the gradation value of at least one pixel selected from the pixels constituting the pattern, and outputting the result to the display device.

The image signal processing method of the third aspect (claim 19) of the present invention has the steps of generating a smoothing signal for smoothing a converted image signal along at least one direction of the image; detecting patterns from the image so that a pattern in which the gradation value of a plurality of pixels selected from a plurality of pixels constituting the display device and arrayed in a continuous fashion in the smoothing direction is a first gradation value, the gradation value of another plurality of pixels adjacent to the plurality of pixels on the smoothing direction side and arrayed in a continuous fashion in this direction is a second gradation value, the absolute value of the difference between a first pre-conversion gradation value corresponding to the first gradation value and a second pre-conversion gradation value corresponding to the second gradation value in the pre-conversion image signal is 1, and the absolute value of the difference between the first gradation value and the second gradation value is equal to or greater than 2; and substituting the smoothed gradation value in place of the gradation value of at least one pixel selected from the pixels constituting the pattern.

### BRIEF DESCRIPTION OF THE DRAWINGS

FIG. 1A is a graph showing variation in an 8-bit gradation value before and after reverse gamma conversion, wherein the horizontal axis is the gradation value of an image signal prior to reverse gamma conversion and the vertical axis is the gradation value of the image signal after reverse gamma conversion, and FIG. 1B is an enlarged view showing the area 100 on the high gradation side of FIG. 1A;

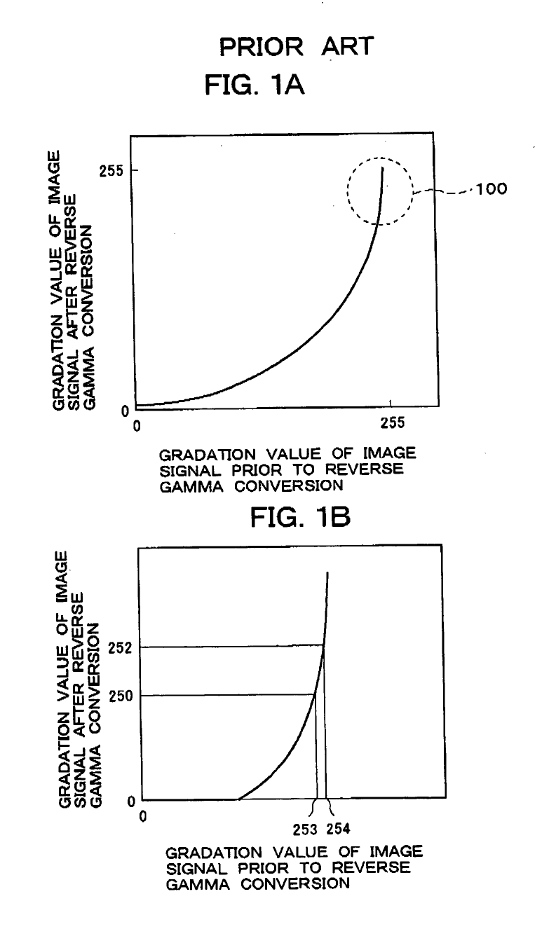

FIG. 2 is a block diagram showing the display apparatus of the first embodiment of the present invention;

FIG. 3 is a block diagram showing the image signal processing circuit of the display apparatus;

FIGS. 4A and 4B are graphs showing the operation of the image signal processing circuit of the present embodiment, wherein the horizontal axis is the position of pixels in the smoothing direction and the vertical axis is the gradation value, FIG. 4A shows the unprocessed image signal, and FIG. 4B shows the processed image signal;

FIG. 5 is a block diagram showing the image signal processing circuit of the second embodiment of the present invention;

FIG. 6 is a block diagram showing the display apparatus of the first example of the present invention;

FIG. 7 is a block diagram showing in detail the image signal processing circuit of the display apparatus;

FIG. 8 is a graph showing the variation of the gradation values before and after the smoothing of the image signal in which the gradation difference is two gradations, wherein the horizontal axis is the pixel position, and the vertical axis is the gradation value;

FIG. 9 is a graph showing the variation of the gradation values before and after the smoothing of the image signal in which the gradation difference is three gradations, wherein the horizontal axis is the pixel position, and the vertical axis is the gradation value;

FIG. 10 is a graph showing the variation of the gradation values before and after the smoothing of the image signal in which the gradation difference is four gradations, wherein the horizontal axis is the pixel position, and the vertical axis is the gradation value; and

FIG. 11 a block diagram showing the display apparatus of the second example of the present invention.

### DESCRIPTION OF THE PREFERRED EMBODIMENTS

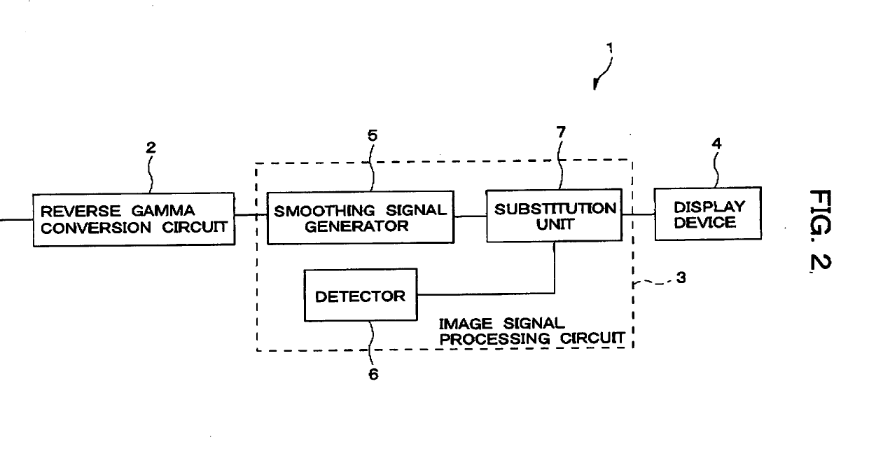

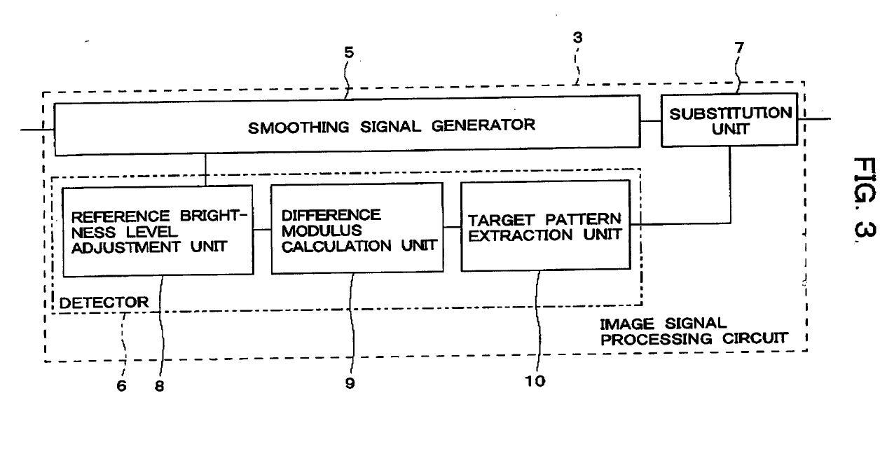

The embodiments of the present invention are described in detail below with reference to the attached diagrams. The first embodiment of the present invention is described first. FIG. 2 is a block diagram showing the display apparatus of the present embodiment, and FIG. 3 is a block diagram showing the image signal processing circuit of the display apparatus.

Provided in the display apparatus 1 of the present embodiment are a reverse gamma conversion circuit 2 for performing a reverse gamma conversion on an externally input image signal, an image signal processing circuit 3 for processing the image signal after reverse gamma conversion, and a display device 4 for displaying an image on the basis of the image signal after the reverse gamma conversion, as shown in FIG. 2. The image signal is an 8-bit digital signal, for example, and the gradation value of the signal is an integer in the range of 0 to 255, representing a gradation of 256. The display device 4 is a display device with linear light-emitting characteristics, a PDP, for example.

In the image signal processing circuit 3, a smoothing signal generator 5 to which an image signal is presented fter reverse gamma conversion is provided for smoothing the image signal along at least one direction of the image, the horizontal direction, for example. The smoothing signal generator 5 calculates the gradation value of a target pixel, for example, from among the pixels of the display device 4, and calculates the mean gradation value of the gradation values of the pixels positioned on both sides, for example, in the horizontal direction of the pixels. For example, the mean value of the target pixel and a single pixel on both sides of the target pixel, totaling three pixels, is calculated, and the value made into an integer by rounding up the places to the right of the decimal point of the mean value is used as the mean gradation value.

In the image signal processing circuit 3, a detector 6 is provided whereby patterns that are subjected to signal processing are detected from images. The patterns include those patterns in the display device 4 in which the gradation value of a plurality of pixels arrayed in a continuous fashion in the above-described smoothing direction; for example, in the horizontal direction is a first gradation value; the gradation value of another plurality of pixels adjacent to the plurality of pixels on the horizontal direction side and arrayed in a continuous fashion in the horizontal direction is a second gradation value; the absolute value of the difference between a first pre-conversion gradation value corresponding to the first gradation value and the second pre-conversion gradation value corresponding to the second gradation value in the image signal prior to reverse gamma conversion is 1; and the absolute value of the difference between first gradation value and the second gradation value after reverse gamma conversion is equal to or greater than 2. A specific example of a pattern is one in which a first pre-conversion gradation value of three or more pixels arrayed in a continuous fashion selected from five or more pixels arrayed in a continuous fashion in the horizontal direction is 253, the second pre-conversion gradation value of the remaining two or more pixels arrayed in a continuous fashion is 254, the absolute value of the difference therebetween is therefore 1; and the first gradation value after reverse gamma conversion is 250, the second gradation value is 252, and the absolute value of the difference therebetween is 2.

In the image signal processing circuit 3, a substitution unit 7 is provided for substituting 251, which is the smoothed gradation value (the mean gradation value described above, for example), in place of the gradation value of at least one pixel selected from the pixels constituting the detected pattern, and outputting the value to the display device 4.

The configuration of the detector 6 is described in detail below. The detector 6 is provided with a reference brightness level adjustment unit 8 presented with the gradation value after reverse gamma conversion and the calculated mean gradation value from the smoothing signal generator 5, a difference modulus calculation unit 9 presented with the output signal of the reference brightness level adjustment unit 8; and a target pattern extraction unit 10 presented with the output signal of the difference modulus calculation unit 9, as shown in FIG. 3.

A reference gradation value is input in advance from the exterior to the reference brightness level adjustment unit 8. The reference gradation value is 128, for example. The reference brightness level adjustment unit 8 outputs to the difference modulus calculation unit 9 a first subtraction gradation value obtained by subtracting the reference gradation value from the gradation value after reverse gamma conversion, and outputs to the difference modulus calculation unit 9 a second subtraction gradation value obtained by subtracting the reference gradation value from the mean gradation value. Here, only an integer equal to 0 or higher is accepted as the first and second subtraction gradation values. When the value obtained by subtracting the reference gradation value from the gradation value after reverse gamma conversion, and the value obtained by subtracting the reference gradation value from the mean gradation value are negative values, the first and second subtraction gradation values are both 0. Therefore, when the gradation value after reverse gamma conversion and the mean gradation value are equal to or less than the reference gradation value, the first and second subtraction gradation values are both 0.

The detector 6 is provided with a difference modulus calculation unit 9 for calculating the absolute value of the difference between the gradation value after reverse gamma conversion and the mean gradation value for each pixel of the display device 4. More specifically, the difference modulus calculation unit 9 calculates the absolute value of the difference between the first subtraction gradation value and the second subtraction gradation value. The detector 6 is furthermore provided with a target pattern extraction unit 10 for extracting patterns having a pixel in which the absolute value calculated by the difference modulus calculation unit 9 is 0, and one or a plurality of pixels that are adjacent on the smoothing direction side of the pixel and that have an absolute value of 1. More specifically, patterns are extracted in which the absolute values are “0, 1”, “0, 1, 1”, “0, 1, 1, 1”, and so forth. The information concerning the extracted pattern is then output to the substitution unit 7.

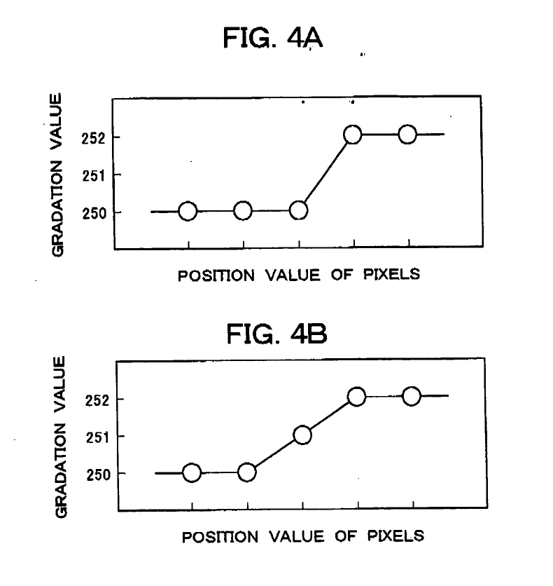

Described next is the operation of the display apparatus of the present embodiment configured in the manner described above. The operation of the display apparatus includes the operation of the image signal processing circuit of the present embodiment, more specifically, the image signal processing method of the present embodiment. FIGS. 4A and 4B are graphs showing the operation of the image signal processing circuit, wherein the horizontal axis is the position of pixels in the smoothing direction and the vertical axis is the gradation value. FIG. 4A shows the unprocessed image signal, and FIG. 4B shows the processed image signal.

First, when an image signal is input to the reverse gamma conversion circuit 2, the reverse gamma conversion circuit 2 performs a reverse gamma conversion operation on the image signal and outputs the result to the smoothing signal generator 5 of the image signal processing circuit 3, as shown in FIG. 2. At this point, in the image signal input to the smoothing signal generator 5, the gradation value of three or more pixels arrayed in a continuous fashion and selected from five or more pixels continuously arrayed in the horizontal direction is 250, and the gradation value of the remaining two or more pixels arrayed in a continuous fashion is 252, as shown in FIG. 4A.

Next, the smoothing signal generator 5 smoothes the image signal after reverse gamma conversion along at least one direction of the image; for example, the horizontal direction. The smoothing signal generator 5 calculates; for example, from among the pixels of the display device 4, the mean value of a target pixel and the pixels positioned on both sides of the target pixel, totaling three pixels. The value made into an integer by rounding up the places to the right of the decimal point of the mean value is used as the mean gradation value. The smoothing signal generator 5 outputs to the substitution unit 7 and reference brightness level adjustment unit 8 both the smoothed and unsmoothed image signals. The reference gradation value is input in advance to the reference brightness level adjustment unit 8.

Next, the reference brightness level adjustment unit 8 calculates a first subtraction gradation value obtained by subtracting the reference gradation value from the gradation value after reverse gamma conversion, and outputs the result to the difference modulus calculation unit 9. The unit also calculates a second subtraction gradation value obtained by subtracting the reference gradation value from the mean gradation value and outputs the result to the difference modulus calculation unit 9. The difference modulus calculation unit 9 then calculates the absolute value of the difference between the gradation value after reverse gamma conversion and the mean gradation value by calculating the absolute value of the difference between the first and second subtraction gradation values for each pixel of the display device 4. The target pattern extraction unit 10 extracts patterns having a pixel in which the absolute value calculated by the difference modulus calculation unit 9 is 0, and one or a plurality of pixels that are adjacent on the smoothing direction side of the pixel and that have an absolute value of 1. More specifically, patterns are extracted in which the absolute values are “0, 1”, “0, 1, 1”, “0, 1, 1, 1”, and so forth. Patterns such as those described above can thereby be detected from the image by the detector 6 as the objects of signal processing. Among the pixels constituting the detected pattern, the information concerning pixels in which the absolute value is “1” is output to the substitution unit 7.

Next, the substitution unit 7 substitutes the smoothed gradation value in place of the gradation value of the pixel in which said absolute value is “1,” and outputs the result to the display device 4. Of the pixels whose gradation value is 250, the gradation value of the pixel adjacent to the pixel whose gradation value is 252 is thereby changed to 251, as shown in FIG. 4B, to perform smoothing. The display device 4 then displays the image on the basis of the image signal in which a smoothed signal has been substituted in place of a portion of the image signal.

The effects of the present embodiment are described next. In the display apparatus 1 of the present embodiment, the smoothing signal generator 5 smoothes the image signal that has been subjected to reverse gamma conversion. The detector 6 detects the patterns described above from the image. More specifically, these are patterns in which a gradation difference of 1 prior to reverse gamma conversion becomes a gradation difference of 2 or more after conversion. The substitution unit 7 uses gradation, conventionally unused in gradation expressions after reverse gamma conversion, to carry out smoothing by substituting the smoothed gradation value in place of the gradation value of at least a single pixel from among the pixels constituting the pattern. The gradation expression in the bright areas of the image can thereby be made smoother and the image quality of the display apparatus can be improved.

Since areas other than the pattern in the image are not smoothed at this time, the image quality prior to smoothing is not compromised. Information or the like expressed by the intermediately gradated areas, dark areas, and detailed patterns of the image thereby remain unsmoothed and the original perceived resolution of the image is not lost. In this manner, in accordance with the present embodiment, the gradation performance of a display device in a display apparatus that performs reverse gamma conversion can be adequately demonstrated.

In the present embodiment, the reference brightness level adjustment unit 8 calculates a subtraction gradation value that is obtained by subtracting a reference gradation value from a gradation value after reverse gamma conversion, and calculates a second subtraction gradation value that is obtained by subtracting a reference gradation value from the mean gradation value. The difference modulus calculation unit 9 can set the first and second subtraction gradation values to 0, and the absolute value of the difference between the gradation value after reverse gamma conversion and the mean gradation value to 0, when the gradation value after reverse gamma conversion and the mean gradation value are equal to or less than the reference gradation value. This is achieved by calculating the absolute value of the difference between the first and second subtraction gradation values for each pixel of the display device 4. The above-described patterns can thereby be detected only in bright areas in which the gradation value after reverse gamma conversion and the mean gradation value are greater than the reference gradation value.

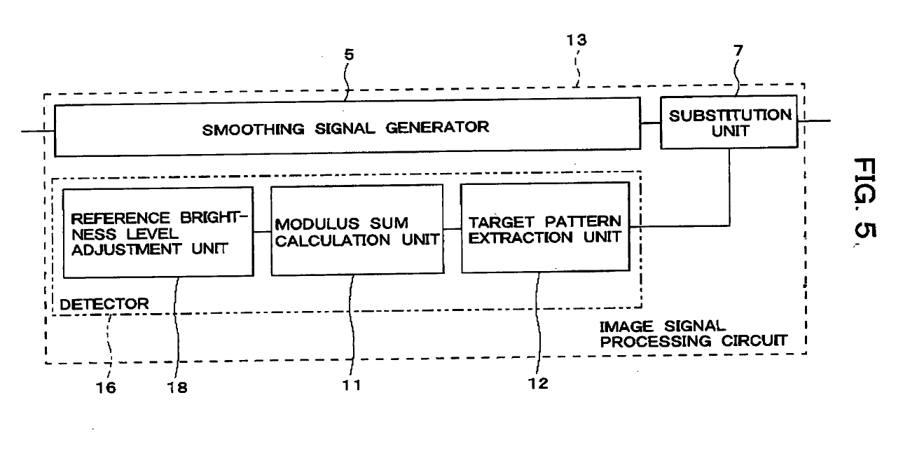

Described next is the second embodiment of the present invention. FIG. 5 is a block diagram showing the image signal processing circuit of the present embodiment. In comparison with the display apparatus (see FIG. 2) of the first embodiment described above, the point of difference in the present embodiment is that a detector 16 is provided in place of the detector 6. More specifically, the present embodiment has a different configuration for detecting target patterns for the signal processing described above in comparison with the first embodiment described above.

In the detector 16 of the image signal processing circuit 13, a reference brightness level adjustment unit 18 is provided for receiving an image signal prior to reverse gamma conversion and calculating a subtraction gradation value that is obtained by subtracting the reference gradation value from the pre-conversion gradation value prior to reverse gamma conversion, as shown in FIG. 5. The detector 16 is provided with a modulus sum calculation unit 11 to which the subtraction gradation value is input from the reference brightness level adjustment unit 18. The modulus sum calculation unit 11 calculates the absolute values of the difference between the subtraction gradation value of the target pixel for each pixel of the display device 4 and the subtraction gradation value of the two pixels that are adjacent on the smoothing direction side of the pixel; for example, on both sides in the horizontal direction, and calculates the sum of the two absolute values.

The detector 16 is provided with a target pattern extraction unit 12 to which the sum of absolute values is input from the modulus sum calculation unit 11, and which extracts patterns having a pixel in which the sum of absolute values is 0, and one or a plurality of pixels that are adjacent on the smoothing direction side of the pixel and that have a sum of absolute values of 1. More specifically, patterns are extracted in which the sums of absolute values are “0, 1”, “0, 1, 1”, “0, 1, 1, 1”, and so forth. Among the pixels constituting the extracted pattern, the information concerning the pixels in which the sum of absolute values is “1” is output to the substitution unit 7. The configuration other than that described above of the present embodiment is the same as the first embodiment described above.

Described next is the operation of the display apparatus of the present embodiment configured in the manner described above. The operation of the reverse gamma conversion circuit 2, the substitution unit 7, and display device 4 in the present embodiment is the same as in the first embodiment described above. The smoothing signal generator 5 does not output to the detector 16 a signal before and after smoothing, and provides output only to the substitution unit 7. The operation of the smoothing signal generator 5 other than that described above is the same as the first embodiment described above. In view of the above, the operation of the detector 16 is described below.

First, an image signal prior to reverse gamma conversion is input to the reference brightness level adjustment unit 18 of the detector 16, as shown in FIG. 5. The reference brightness level adjustment unit 18 calculates the subtraction gradation value obtained by subtracting the reference gradation value from the pre-conversion gradation value prior to reverse gamma conversion, and outputs the result to the modulus sum calculation unit 11.

Next, the modulus sum calculation unit 11 calculates the absolute values of the difference between the subtraction gradation value of the target pixel for each pixel of the display device 4 and the subtraction gradation values of the two pixels that are adjacent on the horizontal direction side of the pixel, and calculates the sum of the two absolute values. At this point, the sum of absolute values is “0” for the pixels whose pre-conversion gradation value is equal to that of the pixels on both sides, and the sum of absolute values is “1” for the pixels whose pre-conversion gradation value is different by exactly 1 from a pixel that is adjacent on one side. The sum of absolute values is “2” or more for pixels whose pre-conversion gradation value is different by two or more from that of the pixel that is adjacent on one side, and for pixels whose pre-conversion gradation value is different from that of both the pixels adjacent on both sides. The modulus sum calculation unit 11 then outputs the sum of absolute values to the target pattern extraction unit 12.

The target pattern extraction unit 12 extracts patterns having a pixel in which the sum of absolute values is 0, and one or a plurality of pixels that are adjacent on the smoothing direction side of the pixel and that have a sum of absolute values of 1. More specifically, patterns are extracted in which the sums of absolute values are “0, 1”, “0, 1, 1”, “0, 1, 1, 1”, and so forth. Among the pixels constituting the extracted pattern, the information concerning the pixels in which the sum of absolute values is “1” is output to the substitution unit 7. The substitution unit 7 then substitutes the smoothed gradation value in place of the gradation value of the pixels in which the absolute value is “1,” and outputs the result to the display device 4. Smoothing can thereby be carried out only in areas in which the pre-conversion gradation value gradually varies. The operation and effects other than that described above of the present embodiment are the same as the first embodiment described above.

Described in the first and second embodiments are examples in which a reference brightness level adjustment unit is provided and patterns are detected only in the bright areas, but the present invention is not limited thereby, and the reference brightness level adjustment unit may be omitted and the patterns detected in all areas of the image. In this case, the image signal that is ultimately input to the display device is the same as the case in which a reference brightness level adjustment unit is provided.

Also, in the first and second embodiments, the smoothing direction is the horizontal direction, but the present invention is not limited thereby, and the smoothing direction may be the vertical direction of the image. Smoothing may alternatively be carried out in both the horizontal and vertical directions.

Described in the first and second embodiments above are examples in which a PDP is used as a display device and a display apparatus is provided with a reverse gamma conversion circuit, but the present invention is not limited thereby, and wide application may be made to display apparatuses in which unused gradations result from the conversion of an image signal. For example, application may be made to display apparatuses in which the light-emission characteristics of the display device are substantially linear and which are provided with a reverse gamma conversion circuit.

Furthermore, a monochromatic image signal was described in the first and second embodiments above, but in the case of a color image, the signal of a single pixel is formed from a plurality of color image signals. The signal of a single pixel is ordinarily formed from the three color image signals red, green, and blue. In such a case, the color signal of each color can be processed in the manner described in the embodiments above. This fact also extends to the following examples.

### EXAMPLES

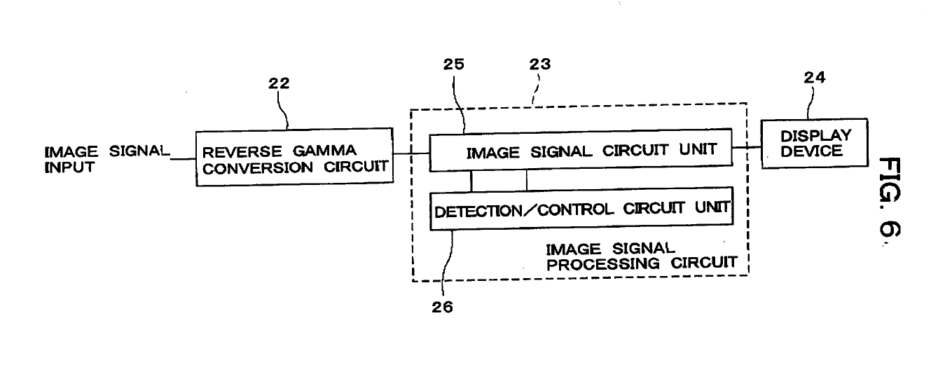

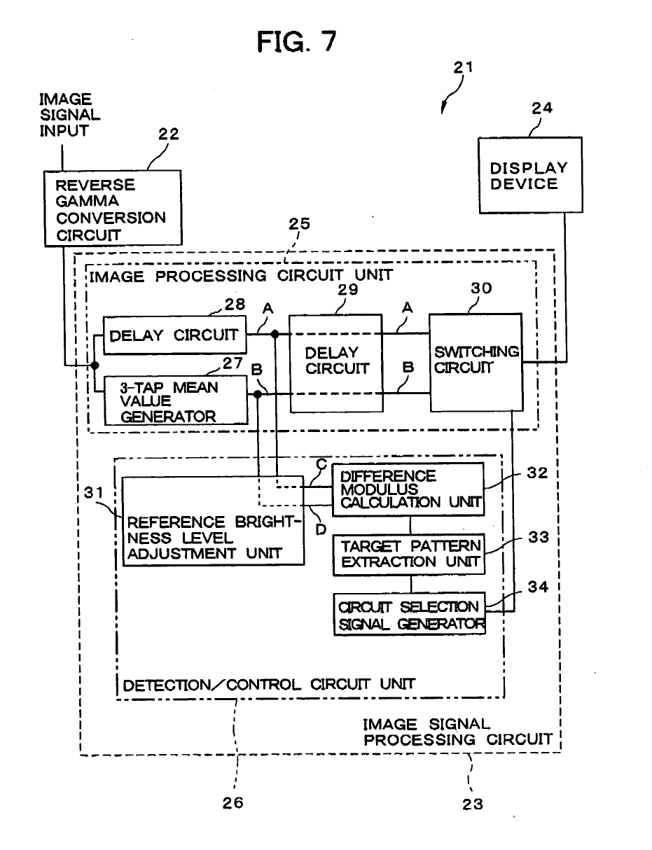

Examples of the present invention are described in detail below with reference to attached diagrams. Following is a description of the first example of the present invention. FIG. 6 is a block diagram showing the display apparatus of the first example of the present invention. FIG. 7 is a block diagram showing the image signal processing circuit of the display apparatus. Provided in the display apparatus 21 of the present example are a reverse gamma conversion circuit 22 for carrying out reverse gamma conversion on digital image signals that are input from outside the display apparatus 21, an image signal processing circuit 23 for receiving image signals after reverse gamma conversion as input from the reverse gamma conversion circuit 22 and processing the image signal, and a display device 24 for displaying images on the basis of image signals output from the image signal processing circuit 23, as shown in FIG. 6. The display device 24 is a PDP, for example.

Provided in the image signal processing circuit 23 are an image processing circuit unit 25 for processing the image signal input from the reverse gamma conversion circuit 22 and outputting the result to the display device 24, and a detection/control circuit unit 26 for receiving as input the image signal from the image processing circuit unit 25, detecting from the image signal patterns that are to be processed as signals, and controlling the image processing circuit unit 25 on the basis of the detected pattern.

In the image processing circuit unit 25, a 3-tap mean value generator 27 and delay circuit 28 are mutually disposed in parallel, and are configured so that the image signals after reverse gamma conversion are input in parallel from the reverse gamma conversion circuit 22, as shown in FIG. 7. The 3-tap mean value generator 27 is a circuit that calculates the mean value of three pixels: one target pixel and two pixels positioned on both sides of the target pixel in the horizontal direction, for example. In the case that a fraction appears to the right of the decimal point in the calculated result, the value is rounded up to produce an integer, and the integer is output. This output value will hereinafter be referred to as “mean gradation value B.” Also, the delay circuit 28 is a circuit for producing a time delay that is equal to that of the 3-tap mean value generator 21. The image signal that is output from the delay circuit 28 will hereinafter be referred to as “image signal A.”

The image processing circuit unit 25 is provided with a delay circuit 29. The delay circuit 29 receives as input an image signal A from the delay circuit 28 and a mean gradation value B from the 3-tap mean value generator 27, adds to the image signal A and mean gradation value B a delay time that is equal to that of the detection/control circuit unit 26, and outputs the result. There is also provided a switching circuit 30 that is presented with the image signal A and the mean gradation value B from the delay circuit 29, and that acts as a substitution unit that outputs to the display device 24 one of the two signals by switching the output.

The detection/control circuit unit 26 is provided with a reference brightness level adjustment unit 31 that accepts as input the mean gradation value B from the 3-tap mean value generator 27 and the image signal A from the delay circuit 28. A preset reference gradation value that is input from the exterior is stored in the reference brightness level adjustment unit 31. The reference brightness level adjustment unit 31 calculates and outputs a first subtraction gradation value C that is obtained by subtracting the reference gradation value from the image signal A, and calculates and outputs a second gradation value D that is obtained by subtracting the reference gradation value from the mean gradation value B.

The detection/control circuit unit 26 is also provided with a difference modulus calculation unit 32 presented with the output signal of the reference brightness level adjustment unit 31, more specifically, the subtraction gradation values C and D; a target pattern extraction unit 33 presented with the output signal of the difference modulus calculation unit 32; and a circuit selection signal generator 34 that is presented with the output signal of the target pattern extraction unit 33 and outputs a control signal to the switching circuit 30 of the image processing circuit unit 25.

The difference modulus calculation unit 32 calculates the absolute value of the difference between the subtraction gradation value C and the subtraction gradation value D (|C−D|), and outputs the result to the target pattern extraction unit 33. The target pattern extraction unit 33 extracts patterns in which pixels that have an absolute value of 1 are present in a continuous fashion in the horizontal direction, for example, and immediately follow a pixel that has an absolute value of 0. More specifically, patterns are extracted in which the absolute values are “0, 1”, “0, 1, 1”, “0, 1, 1, 1”, and so forth.

The patterns are target patterns that are the objects of smoothing in the present example, and are areas in which the brightness variation is gradual. For this reason, the patterns are defined below. The boundary of a pair of pixels that are mutually adjacent and have mutually different gradation values is hereinafter referred to as the “point of variation.”

(1) The gradation values are the same for three consecutive pixels or more up to the point df variation.

(2) The gradation values are the same for two consecutive pixels or more up to the point of variation.

(3) The gradation difference of the point of variation is two gradations or three gradations.

The definition of (3) above is based on the fact that the gradation difference that is 1 prior to reverse gamma conversion reaches a maximum gradation difference of 3 after reverse gamma conversion. In accordance with this definition, the gradation of patterns with this characteristic does not vary by three gradations or more at the point of variation, and one of the two pixels positioned on both sides of the pixel in contact with the point of variation has the same gradation as the pixel in contact with the point of variation. For this reason, the calculation result of the 3-tap mean value is 2/3=0.67 at the point of variation when the gradation difference from center pixel is two gradations. The result 0.67 is rounded up to produce a result of 1. When the gradation difference from the center pixel is three gradations or more, the result is 3/3=1. Based on this fact, the difference between the 3-tap mean value and the image signal (original signal) of the area in which the brightness variation is defined as being gradual is always equal to “1.” Also, since data is present in which there are three or more consecutive pixels up to the point of variation, the image signal (original signal) and the 3-tap mean value just prior to the point of variation are mutually equal, and the difference between the two is “0.” The target pattern extraction unit 33 defines as the target pattern the area in which an array of absolute values is “0, 1”, “0, 1, 1”, “0, 1, 1, 1”, and so forth, that is to say, an area in which 1's are present in a continuous fashion immediately after a 0.

The circuit selection signal generator 34 outputs a control signal to the switching circuit 30. Among the plurality of pixels constituting the pattern that the target pattern extraction unit 33 has extracted as the target pattern, the control signal causes the switching circuit 30 to switch to the mean gradation value B that is output from the 3-tap mean value generator 27 for pixels in which the absolute value of the difference is “1,” and to switch the output to image signal A that is output from the delay circuit 28 for other pixels. The switching circuit 30 switches the output to the display device 24 on the basis of the control signal output from the circuit selection signal generator 34.

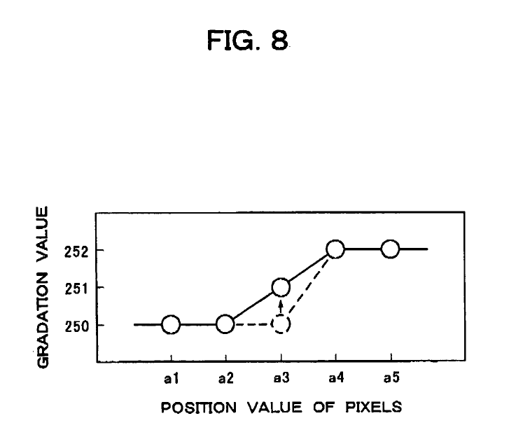

Described next is the operation of the display apparatus of the present example configured in the manner described above. FIGS. 8 to 10 are graphs that show the variation of the gradation values before and after the smoothing, wherein the horizontal axis is the pixel position, and the vertical axis is the gradation value. For graphing convenience, the addresses a1 to a5 shown in the graphs are assigned from left to right along the horizontal axes of FIGS. 8 to 10. The addresses a1 to a5 represent the positions of five pixels disposed in a continuous fashion along an arbitrary direction on the screen. The circles shown with a broken line in FIGS. 8 to 10 represent the gradation value prior to smoothing.

Described first is an example in which the gradation difference after reverse gamma conversion is two gradations. TABLE 1 shows an example of the gradation values and other numerical values of a group of pixels that is to be processed. The gradation values before and after smoothing in the processing example shown in TABLE 1 are reflected in FIG. 8.

When the image signal, which is an 8-bit digital signal, is input to the reverse gamma conversion circuit 22, the reverse gamma conversion circuit 22 carries out reverse gamma conversion on the image signal, and the result is input in parallel to the 3-tap mean value generator 27 and delay circuit 28, as shown in FIG. 7.

At this point, the gradation values of five pixels that are continuous in the horizontal direction are 250, 250, 250, 252, and 252, as shown in TABLE 1 and FIG. 8. More specifically, the processing example shown the TABLE 1 and FIG. 8 is the example of a signal in which the gradation value changes by two gradations from 250 to 252. The gradation value of the pixel at position a0 (not shown) positioned to the left of the pixel of position a1 shown in FIG. 8 is the same (250) as that of position a1, and the gradation value of the pixel at position a6 (not shown) positioned to the right of the pixel of position a5 is the same (252) as that of position a5.

TABLE 1

| | | PIXEL POSITION | | | | |
|---|---|---|---|---|---|---|
| | | a1 | a2 | a3 | a4 | a5 |
| AFTER | IMAGE | 250 | 250 | 250 | 252 | 252 |
| REVERSE | SIGNAL A | | | | | |
| GAMMA | MEAN | 250 | 250 | 251 | 252 | 252 |
| CONVERSION | GRADATION | | | | | |
| | VALUE B | | | | | |
| REFERENCE | SUBTRACTION | 122 | 122 | 122 | 124 | 124 |
| GRADATION | GRADATION | | | | | |
| VALUE AFTER | VALUE C | | | | | |
| SUBTRACTION | SUBTRACTION | 122 | 122 | 123 | 124 | 124 |
| | GRADATION | | | | | |
| | VALUE D | | | | | |

| | | | | | |
|---|---|---|---|---|---|
| DIFFERENCE BETWEEN | 0 | 0 | 1 | 0 | 0 |
| ABSOLUTE VALUES \|C − D\| | | | | | |
| TARGET PATTERN | X | ◯ | ◯ | X | X |
| OUTPUT CIRCUIT | A | A | B | A | A |
| SELECTION (A OR B) | | | | | |
| GRADATION VALUE OF THE | 250 | 250 | 251 | 252 | 252 |
| OUTPUT SIGNAL | | | | | |

The 3-tap mean value generator 27 calculates for all pixels the mean gradation value B of the target pixel and the pixels adjacent on both sides in the horizontal direction of the target pixel. At this point, the places to the right of the decimal point are rounded up in order to form an integer value. The mean gradation value B at positions a1 and a2 is 250, the mean gradation value B at position a3 is 251, and the mean gradation value B at positions a4 and a5 is 252, as shown in TABLE 1. The 3-tap mean value generator 27 also outputs the mean gradation value B to both the delay circuit 29 and the reference brightness level adjustment unit 31.

On the other hand, the delay circuit 28 delays the image signal A that is input from the reverse gamma conversion circuit 22 by an amount equal to the delay of the 3-tap mean value generator 27. The delay circuit 28 outputs the image signal A to both the delay circuit 29 and the reference brightness level adjustment unit 31.

Next, the reference brightness level adjustment unit 31 outputs to the difference modulus calculation unit 32 a subtraction gradation value C that is obtained by subtracting the reference gradation value (128, for example) from the image signal A, and outputs to the difference modulus calculation unit 32 a subtraction gradation value D that is obtained by subtracting the reference gradation value (128, for example) from the mean gradation value B. The processing described below can thereby be carried out on the bright areas with a gradation of 128 or greater.

Next, the difference modulus calculation unit 32 calculates the absolute value of the difference between the subtraction gradation value C and the subtraction gradation value D (|C−D|). The absolute value of the difference is 1 in the pixel of position a3, and is 0 in other pixels, as shown in TABLE 1. In other words, the pattern is 0, 0, 1, 0, and 0. The absolute value of the difference is output to the target pattern extraction unit 33.

Next, the target pattern extraction unit 33 extracts from the absolute value of the difference the pattern targeted for smoothing. As described above, the pattern has a single pixel whose absolute value is “0, 1” and also has one or a plurality of pixels that are disposed in a continuous fashion in the smoothing direction, beginning from the single pixel, and have an absolute value of “1.” In the example shown in TABLE 1, the absolute value of the pixel of position a2 is “0,” and the absolute value of the pixel in position a3 is “1.” Therefore, the target pattern extraction unit 33 determines that the pixels in positions a2 and a3 form a target pattern that contains the absolute value array “0, 1” and extracts the pattern. The extraction result is then output to the circuit selection signal generator 34.

In the subsequent case that a set of pixels constitutes a target pattern and the absolute value of the difference is “1,” the circuit selection signal generator 34 outputs a control signal to the switching circuit 30 so as to cause the mean gradation value B that is output from the 3-tap mean value generator 27 to be output. In other cases, that is to say, when the absolute value of the difference of a set of pixels constituting the target pattern is “0,” a control signal is output to the switching circuit 30, causing the image signal A that is output from the delay circuit 28 to be output.

On the other hand, the delay circuit 29 of the image processing circuit unit 25 adds to the image signal A and mean gradation value B a delay that is equal to the time required by the detection/control circuit unit 26, that is to say, a delay that is equal to the time interval that begins when the image signal A and mean gradation value B are input to the reference brightness level adjustment unit 31 and ends when the circuit selection signal generator 34 outputs a control signal. The result is output to the switching circuit 30.

Next, the switching circuit 30 switches the output to the display device 24 on the basis of the control signal that is input from the circuit selection signal generator 34. More specifically, in the example shown in TABLE 1, the mean gradation value B is output for the pixel in position a3, and the image signal A is output for the other pixels. In other words, the mean gradation value B is substituted in place of the image signal A only for the pixel in position a3. In the image signal (“image signal” shown in TABLE 1) that is output from the switching circuit 30, the gradation value of the pixel positioned in position a3 is 251, as shown in TABLE 1 and FIG. 8.

As a result, the image signal in which the gradation values of consecutive pixels was 250, 250, 250, 252, and 252 becomes 250, 250, 251, 252, and 252, and the new pattern is output from the image signal processing circuit 23. The display device 4 then displays the image on the basis of the output signal. The gradation difference can thereby be interpolated, as shown in FIG. 8, by substituting the signal of the gradation 251 in place of the signal of the gradation 250 at the point of variation between gradations 250 and 252. Thus, the gradation 251 that was not conventionally used can be effectively used to provide a smooth gradation expression.

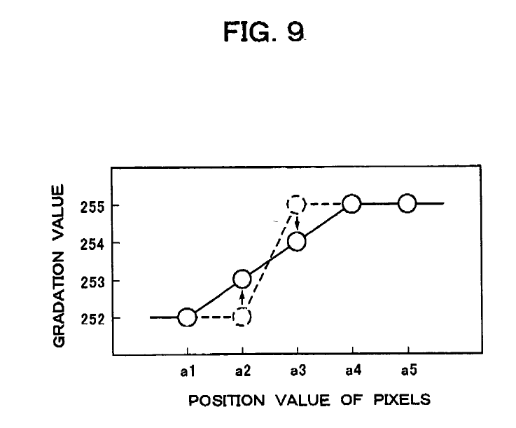

Described next is an example in which the gradation difference after reverse gamma conversion is three gradations. TABLE 2 shows an example of the gradation values and other numerical values of a group of pixels that is to be processed. The gradation values before and after smoothing in the processing example shown in TABLE 2 are reflected in FIG. 9. The gradation values after reverse gamma conversion for the consecutive pixels are 252, 252, 255, 255, and 255, as shown in TABLE 2 and FIG. 9, and the gradation difference at the point of variation is three gradations. The qualitative operation of the display apparatus 21 is the same as the operation described using TABLE 1 and FIG. 8 above, so a description is omitted and only the quantitative operation is described below.

TABLE 2

| | | PIXEL POSITION | | | | |
|---|---|---|---|---|---|---|
| | | a1 | a2 | a3 | a4 | a5 |
| AFTER | IMAGE | 252 | 252 | 255 | 255 | 255 |
| REVERSE | SIGNAL A | | | | | |
| GAMMA | MEAN | 252 | 253 | 254 | 255 | 255 |
| CONVERSION | GRADATION | | | | | |
| | VALUE B | | | | | |
| REFERENCE | SUBTRACTION | 124 | 124 | 127 | 127 | 127 |
| GRADATION | GRADATION | | | | | |
| VALUE AFTER | VALUE C | | | | | |
| SUBTRACTION | SUBTRACTION | 124 | 125 | 126 | 127 | 127 |
| | GRADATION | | | | | |
| | VALUE D | | | | | |

| | | | | | |
|---|---|---|---|---|---|
| DIFFERENCE BETWEEN | 0 | 1 | 1 | 0 | 0 |
| ABSOLUTE VALUES \|C − D\| | | | | | |
| TARGET PATTERN | ◯ | ◯ | ◯ | X | X |
| OUTPUT CIRCUIT | A | B | B | A | A |
| SELECTION (A OR B) | | | | | |
| GRADATION VALUE OF THE | 252 | 253 | 254 | 255 | 255 |
| OUTPUT SIGNAL | | | | | |

The gradation values of the image signal A output from the reverse gamma conversion circuit 22 are 252, 252, 255, 255, and 255, as shown in TABLE 2. The 3-tap mean value generator 27 determines that the mean gradation values B generated based on the image signal are 252, 253, 254, 255, and 255. Therefore, when the reference gradation value that is input to the reference brightness level adjustment unit 31 is 128, the subtraction gradation values C that are obtained by subtracting the reference gradation value from the image signal A are 124, 124, 127, 127, and 127; and the subtraction gradation values D that are obtained by subtracting the reference gradation value from the mean gradation value B are 124, 125, 126, 127, and 127.

The absolute value of the difference between the subtraction gradation values C and D (|C−D|) that is calculated by the difference modulus calculation unit 32 is therefore 0, 1, 1, 0, and 0. The target pattern extraction unit 33 then extracts, as the target pattern, a pattern in which the array of absolute values has a pattern “0, 1, 1”; that is to say, a pattern having a three pixels in the positions a1, a2, and a3. As a result, the circuit selection signal generator 34 outputs a control signal to the switching circuit 30 to cause a mean gradation value B to be output for the pixels in which the absolute value is “1” from among the pixels constituting the pattern, in other words, pixels that are in the positions a2 and a3, and an image signal A to be output for other pixels. The gradation values of the pixels in the positions a1 to a5 are thereby made to be 252, 253, 254, 255, and 255 in the output signal of the switching circuit 30. As a result, at the point of variation at which the gradation value between the positions a2 and a3 varies from 252 to 255, the gradation value of the position a2 can be increased from 252 to 253 and the gradation value of the position a3 can be reduced from 255 to 254, as shown in FIG. 9. The gradation difference of the image can thereby be interpolated and the gradation expression can be made smoother.

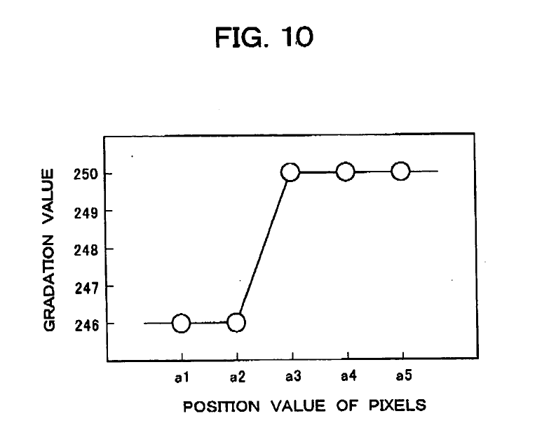

Described next is an example in which the gradation difference after reverse gamma conversion is four gradations. TABLE 3 shows an example of the gradation values and other numerical values of a group of pixels that is to be processed. The gradation values before and after smoothing in the processing example shown in TABLE 3 are reflected in FIG. 10. The gradation values after reverse gamma conversion for the consecutive pixels are 246, 246, 250, 250, and 250, as shown in TABLE 3 and FIG. 10, and have a gradation variation of four gradations from gradation 246 to gradation 250 at the point of variation. The gradation values of the image signal A that is output from the reverse gamma conversion circuit 22 are 246, 246, 250, 250, and 250, as shown in TABLE 3. The 3-tap mean value generator 27 determines that the mean gradation values B generated based on the image signal are 246, 248, 249, 250, and 250. Therefore, when the reference gradation value that is input to the reference brightness level adjustment unit 31 is 128, the subtraction gradation values C that are obtained by subtracting the reference gradation value from the image signal A are 118, 118, 122, 122, and 122; and the subtraction gradation values D that are obtained by subtracting the reference gradation value from the mean gradation value B are 118, 120, 121, 122, and 122.

TABLE 3

| | | PIXEL POSITION | | | | |
|---|---|---|---|---|---|---|
| | | a1 | a2 | a3 | a4 | a5 |
| AFTER | IMAGE | 246 | 246 | 250 | 250 | 250 |
| REVERSE | SIGNAL A | | | | | |
| GAMMA | MEAN | 246 | 248 | 249 | 250 | 250 |
| CONVERSION | GRADATION | | | | | |
| | VALUE B | | | | | |
| REFERENCE | SUBTRACTION | 118 | 118 | 122 | 122 | 122 |
| GRADATION | GRADATION | | | | | |
| VALUE AFTER | VALUE C | | | | | |
| SUBTRACTION | SUBTRACTION | 118 | 120 | 121 | 122 | 122 |
| | GRADATION | | | | | |
| | VALUE D | | | | | |

| | | | | | |
|---|---|---|---|---|---|
| DIFFERENCE BETWEEN | 0 | 2 | 1 | 0 | 0 |
| ABSOLUTE VALUES \|C − D\| | | | | | |
| TARGET PATTERN | X | X | X | X | X |
| OUTPUT CIRCUIT | A | A | A | A | A |
| SELECTION (A OR B) | | | | | |
| GRADATION VALUE OF THE | 246 | 246 | 250 | 250 | 250 |
| OUTPUT SIGNAL | | | | | |

The absolute value of the difference between the subtraction gradation values C and D (|C−D|) that are calculated by the difference modulus calculation unit 32 is therefore 0, 2, 1, 0, and 0. The target pattern extraction unit 33 therefore determines that the image does not contain a target pattern in which an array of absolute values in the image is “0, 1”, “0, 1, 1”, “0, 1, 1, 1”, and so forth. As a result, the switching circuit 30 outputs the image signal A for all pixels. Thus, for the point of variation at which the gradation difference is four or more, it is determined that the point of variation at which the gradation difference was a single gradation prior to reverse gamma conversion did not increase to a gradation difference of four due to reverse gamma conversion, but that the gradation difference prior to reverse gamma conversion was two gradations or more, and smoothing is not carried out at the point of variation.

Thus, in accordance with the present example, the 3-tap mean value generator calculates the mean gradation value B from the image signal after reverse gamma conversion, the detection/control circuit unit 26 detects the target pattern described above from the image by using the image signal A and the mean gradation value B, and the switching circuit 30 outputs a mean gradation value B as the gradation value of pixels in which the absolute value (|C−D|) is 1 from among the pixels constituting the target pattern. The conventionally unused gradation value can thereby be used to perform smoothing at the point of variation at which the gradation difference is two gradations or more through reverse gamma conversion. Since smoothing is not carried out in areas other than the point of variation, the image quality prior to smoothing, that is, the original perceived resolution of the image, is not compromised. In accordance with the present example, the gradation performance of a display device can thereby be sufficiently demonstrated in a display apparatus in which reverse gamma conversion is performed.

In the present example, the reference brightness level adjustment unit 31 calculates the subtraction gradation value C from the image signal A and calculates the subtraction gradation value D from the mean gradation value B. The difference modulus calculation unit 32 can limit detection of the patterns described above to bright areas in which the image signal A and the mean gradation value B are greater than the reference gradation value by calculating the absolute value of the difference between the subtraction gradation values C and D for each pixel of the display device 4.

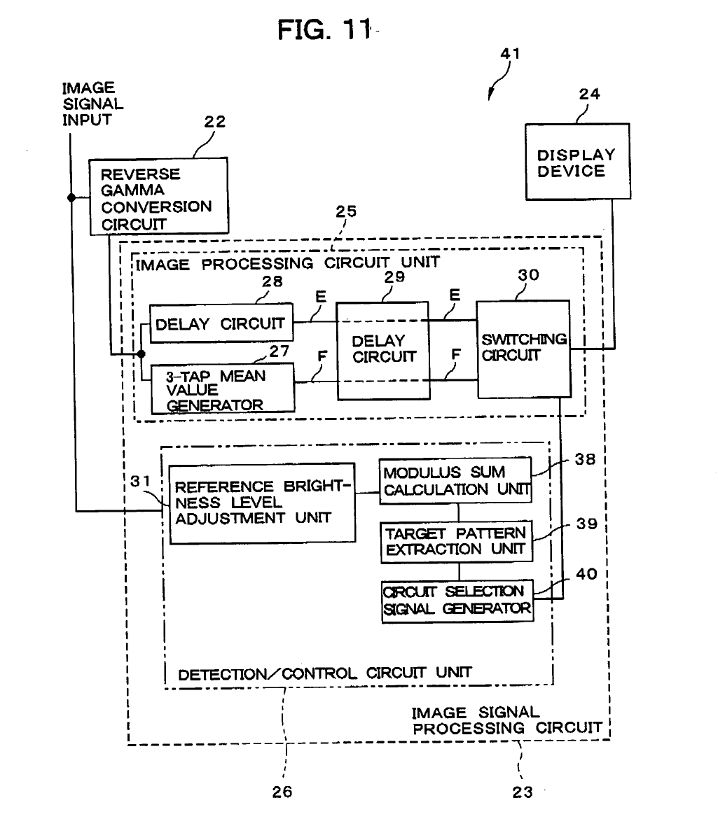

Described next is the second example of the present invention. FIG. 11 a block diagram showing the display apparatus of the present example. In the display apparatus 41 of the present example, the configuration of the image processing circuit unit is the same as that of the first example described above, as shown in FIG. 11. However, the output signals of the 3-tap mean value generator 27 and delay circuit 28 are output only to the delay circuit 29 and are not output to the detection/control circuit unit 26. Hereinbelow, the image signal that is output from the delay circuit 28 is referred to as the “image signal E,” and the mean gradation value that is output from the 3-tap mean value generator 27 is referred to as the “mean gradation value F.”

The display apparatus of the present example has a detection/control circuit unit whose structure is different than that of the first example described above. More specifically, the detection/control circuit unit 26 is provided with a reference brightness level adjustment unit 37, a modulus sum calculation unit 38, a target pattern extraction unit 39, and a circuit selection signal generator 40. In contrast to the first example described above, the reference brightness level adjustment unit 37 does not receive the output signals of the 3-tap mean value generator 27 and the delay circuit 28 in the present example, but receives as input the image signal prior to reverse gamma conversion, calculates a subtraction gradation value that is obtained by subtracting the reference gradation value from the gradation value of the image signal prior to reverse gamma conversion, that is, the pre-conversion gradation value, and outputs the result to the modulus sum calculation unit 38.

The modulus sum calculation unit 38 calculates the absolute values of the gradation value differences between the target pixel and the pixels on both sides in the smoothing direction for each pixel of the display device 4 on the basis of the subtraction gradation value, calculates the sum of the two absolute values, and outputs the result to the target pattern extraction unit 39.

Based on the sum of the absolute values, the target pattern extraction unit 39 extracts target patterns to be smoothed. The target pattern is a pattern in which the sums of the absolute values are “1's” that are present in a continuous fashion immediately following a value “0”, more specifically, patterns in which the absolute values are “0, 1”, “0, 1, 1”, “0, 1, 1, 1”, and so forth. In the same manner as the first example described above, the area in which smoothing is desired is an area with gradual brightness variation, but in contrast to the first example described above, the target patterns are defined as follows in the present example since the image signal prior to reverse gamma conversion is used to detect target patterns.

(1) The gradation values are the same for three consecutive pixels or more up to and including the point of variation.

(2) The gradation values are the same for two consecutive pixels or more beginning from the point of variation.

(3) The gradation difference of the point of variation is a single gradation.

In accordance with this definition, the sum of absolute values of the gradation value differences between a pixel adjacent to the point of variation and adjacent pixels on both sides of this pixel is 1 at the point of variation. For a pixel that is one position in front of the pixel immediately preceding the point of variation, the same data is aligned in a continuous fashion for the pixel and the pixels adjacent thereto, so the sum of absolute values of the adjacent pixel differences is “0.” In view of the above, the target pattern extraction unit 39 defines and extracts as the target pattern the area in which the sums of absolute values are “0, 1”, “0, 1, 1”, “0, 1, 1, 1”, and so forth, that is to say, an area in which 1's are present in a continuous fashion immediately after a 0. The result of this extraction is output to the circuit selection signal generator 40.

The circuit selection signal generator 40 performs switching so that the switching circuit 30 is connected to the wiring that is connected to the 3-tap mean value generation circuit of the delay circuit 29, and generates a control signal that causes the image signal E to be output from the switching circuit 30 only in the case that the sum of absolute values is “1” in the pattern extracted as the target pattern; and in other cases performs switching so that the switching circuit 30 is connected to the wiring that is connected to the delay circuit 28 of the delay circuit 29, generates a control signal that causes the mean gradation value F to be output from the switching circuit 30, and outputs the result to the switching circuit 30.

Described next is the operation of the display apparatus of the present example. Described first is an example in which the gradation difference after reverse gamma conversion is two gradations. TABLE 4 shows an example of the gradation values and other numerical values of a group of pixels that is to be processed. The gradation values before and after smoothing in the processing example shown in TABLE 4 are the same as the gradation values shown in FIG. 9. First, the image signal prior to reverse gamma conversion is input in parallel to the reverse gamma conversion circuit 22 and the reference brightness level adjustment unit 37, as shown in FIG. 11. At this point, the gradation values prior to reverse gamma conversion of each of the pixels in positions a1 to a5 are 253, 253, 253, 254, and 254, as shown in TABLE 4. The reference gradation value is 128.

TABLE 4

| | | PIXEL POSITION | | | | |
|---|---|---|---|---|---|---|
| | | a1 | a2 | a3 | a4 | a5 |
| AFTER | IMAGE | 250 | 250 | 250 | 252 | 252 |
| REVERSE | SIGNAL E | | | | | |
| GAMMA | MEAN | 250 | 250 | 251 | 252 | 252 |
| CONVERSION | GRADATION | | | | | |
| | VALUE F | | | | | |

| | | | | | |
|---|---|---|---|---|---|
| GRADATION VALUE BEFORE | 253 | 253 | 253 | 254 | 254 |
| REVERSE GAMMA | | | | | |
| CONVERSION | | | | | |
| SUBTRACTION GRADATION | 125 | 125 | 125 | 126 | 126 |
| VALUE | | | | | |
| SUM OF ABSOLUTE VALUES | 0 | 0 | 1 | 1 | 0 |
| OF TWO ADJACENT | | | | | |
| DIFFERENCES | | | | | |
| TARGET PATTERN | X | ◯ | ◯ | ◯ | X |
| OUTPUT CIRCUIT | E | E | F | F | E |
| SELECTION (E OR F) | | | | | |
| GRADATION VALUE OF THE | 250 | 250 | 251 | 252 | 252 |
| OUTPUT SIGNAL | | | | | |

The operation of the reverse gamma conversion circuit 22, image processing circuit unit 25, and display device 4 in the present example is the same as that of the first example described above. In other words, the reverse gamma conversion circuit 22 carries out reverse gamma conversion on the image signal and outputs the signal to the 3-tap mean value generator 27 and delay circuit 28. The gradation values after reverse gamma conversion are 250, 250, 250, 252, and 252, as shown in TABLE 4. The 3-tap mean value generator 27 subsequently generates a 3-tap mean gradation value F from the image signal and outputs the result to the delay circuit 29. At this point, the mean gradation values F are 250, 250, 251, 252, and 252. The delay circuit 28 adds to the image signal a delay that is equal to that of the 3-tap mean value generator 27, and outputs the result as image signal E to the delay circuit 29. At this point, the 3-tap mean value generator 27 and delay circuit 28 do not output the resulting output signal to the detection/control circuit unit 26. The delay circuit 29 adds to the image signal E and the mean gradation value F a delay that is equal to that of the detection/control circuit unit 26, and outputs the result to the switching circuit 30.

In the detection/control circuit unit 26, the reference brightness level adjustment unit 37 subtracts the reference gradation value from the pre-conversion gradation value and calculates the subtraction gradation value. The subtraction gradation value becomes 125, 125, 125, 126, 126, as shown in TABLE 4. The bright areas in which the gradations are 128 or higher can thereby be the objects of subsequent processing. The subtraction gradation value is then output to the modulus sum calculation unit 38.

Next, the modulus sum calculation unit 38 calculates for each pixel the absolute values of the differences between the subtraction gradation value of the target pixel and the subtraction gradation value of the adjacent pixels, and then calculates the sums of the absolute values. The sums of absolute values are 0, 0, 1, 1, 0, as shown in TABLE 4. The sums of the absolute values are then output to the target pattern extraction unit 39.

The target pattern extraction unit 39 then extracts from the sums of the absolute values the patterns that are subjected to signal processing. As described above, the pattern has a single pixel whose sum of absolute values is “0,” and one or a plurality of pixels that are disposed in a continuous fashion in the smoothing direction beginning from the single pixel and have an absolute value of “1.” In the example shown in TABLE 4, the absolute value of the pixel of position a2 is “0,” and the absolute value of the pixels in positions a3 and a4 is “1.” More specifically, an array Of sums of absolute values “0, 1, 1” is realized in the pixels in the positions of a2 to a4. Therefore, the target pattern extraction unit 39 determines that the pattern having the three pixels in positions a2 to a4 form a target pattern and extracts the pattern. The extraction result is then output to the circuit selection signal generator 40.

In the subsequent case that a set of pixels constitutes a target pattern, more specifically, when the absolute value of sums is “1” in the positions a2 to a4, the circuit selection signal generator 40 outputs a control signal to the switching circuit 30 so as to cause the mean gradation value F to be output, and in other cases the switching circuit 30 is presented with a control signal that causes the image signal E to be output.

As a result, the switching circuit 30 switches the output to the display device 24 on the basis of the control signal that is input from the target pattern extraction unit 39. In other words, in the example shown in TABLE 4, the mean gradation value F is output for the pixels in the positions a3 and a4, and the image signal E is output for other pixels. The gradation value of the pixel in position a3 becomes 251 in the image signal (“output signal” shown in TABLE 4) that is output from the switching circuit 30, as shown in TABLE 4 and FIG. 8.

As a result, the image signal in which the gradation values of the pixels were aligned in a continuous fashion 250, 250, 250, 252, and 252 become an output signal of 250, 250, 251, 252, and 252 that is output from the image signal processing circuit 23. The display device 4 then displays the image on the basis of the output signal. The gradation difference can thereby be interpolated by substituting the signal of the gradation 251 in place of the signal of the gradation 250 at the point of variation between the gradation 250 and gradation 252, as shown in FIG. 8.

Described next is an example in which the gradation difference after reverse gamma conversion is three gradations. TABLE 5 shows an example of the gradation values and other numerical values of a group of pixels that is to be processed. The gradation values before and after smoothing in the processing example shown in TABLE 5 are the same as the gradation values shown in FIG. 9. The gradation values prior to reverse gamma conversion for the consecutive pixels are 254, 254, 255, 255, and 255, as shown in TABLE 5 and FIG. 9. The qualitative operation of the display apparatus 41 is the same as the operation described using TABLE 4 and FIG. 8 above, so a description is omitted and only the quantitative operation is described below.

TABLE 5

| | | PIXEL POSITION | | | | |
|---|---|---|---|---|---|---|
| | | a1 | a2 | a3 | a4 | a5 |
| AFTER | IMAGE | 252 | 252 | 255 | 255 | 255 |
| REVERSE | SIGNAL E | | | | | |
| GAMMA | MEAN | 252 | 253 | 254 | 255 | 255 |
| CONVERSION | GRADATION | | | | | |
| | VALUE F | | | | | |

| | | | | | |
|---|---|---|---|---|---|
| GRADATION VALUE BEFORE | 254 | 254 | 255 | 255 | 255 |
| REVERSE GAMMA | | | | | |
| CONVERSION | | | | | |
| SUBTRACTION GRADATION | 126 | 126 | 127 | 127 | 127 |
| VALUE | | | | | |
| SUM OF ABSOLUTE VALUES | 0 | 1 | 1 | 0 | 0 |
| OF TWO ADJACENT | | | | | |
| DIFFERENCES | | | | | |
| TARGET PATTERN | ◯ | ◯ | ◯ | X | X |
| OUTPUT CIRCUIT | E | F | F | E | E |
| SELECTION (E OR F) | | | | | |
| GRADATION VALUE OF THE | 252 | 253 | 254 | 255 | 255 |
| OUTPUT SIGNAL | | | | | |

The gradation values of the image signal E that is output from the reverse gamma conversion circuit 22 are 252, 252, 255, 255, 255, as shown in TABLE 5. The mean gradation values F that the 3-tap mean value generator 27 generates based on the image signal are 252, 253, 254, 255, and 255.

The subtraction gradation values that are obtained by subtracting the reference gradation value (128) from the pre-conversion gradation values are 126, 126, 127, 127, and 127. Therefore, the absolute values of the sums calculated by the modulus sum calculation unit 38 are 0, 1, 1, 0, and 0. The target pattern extraction unit 39 extracts, as target patterns, patterns in which the array of sums of absolute values is “0, 1, 1”; more specifically, patterns having three pixels in the positions a1 to a3. As a result, the circuit selection signal generator 40 outputs to the switching circuit 30 the mean gradation value F for pixels with an absolute value of “1,” in other words, pixels in the positions a2 and a3 from among the pixels constituting the target pattern, and for other pixels a control signal is output that causes the image signal E to be output. The gradation values of the pixels in positions a1 to a5 thereby become 252, 253, 254, 255, and 255 in the output signal of the switching circuit 30.

As a result, at the point of variation at which the gradation value between the positions a2 and a3 varies from 252 to 255, the gradation value of the position a2 can be increased from 252 to 253 and the gradation value of the position a3 can be reduced from 255 to 254, as shown in FIG. 9. The gradation difference of the image can thereby be interpolated and the gradation expression can be made smoother.

Described next is an example in which the gradation difference after reverse gamma conversion is four gradations. TABLE 6 shows an example of the gradation values and other numerical values of a group of pixels that is to be processed. The gradation values before and after smoothing in the processing example shown in TABLE 6 are the same as the gradation values shown in FIG. 10. The gradation values prior to reverse gamma conversion for the consecutive pixels are 251, 251, 253, 253, and 253, as shown in TABLE 6 and FIG. 10. The gradation values of the image signal E that is output from the reverse gamma conversion circuit 22 are 246, 246, 250, 250, and 250, as shown in FIG. 6. The mean gradation value F that is generated by the 3-tap mean value generator 27 on the basis of the image signal is 246, 248, 249, 250, and 250.

TABLE 6

| | | PIXEL POSITION | | | | |
|---|---|---|---|---|---|---|
| | | a1 | a2 | a3 | a4 | a5 |
| AFTER | IMAGE | 246 | 246 | 250 | 250 | 250 |
| REVERSE | SIGNAL E | | | | | |
| GAMMA | MEAN | 246 | 248 | 249 | 250 | 250 |
| CONVERSION | GRADATION | | | | | |
| | VALUE F | | | | | |

| | | | | | |
|---|---|---|---|---|---|
| GRADATION VALUE BEFORE | 251 | 251 | 253 | 253 | 253 |
| REVERSE GAMMA | | | | | |
| CONVERSION | | | | | |
| SUBTRACTION GRADATION | 123 | 123 | 125 | 125 | 125 |
| VALUE | | | | | |
| SUM OF ABSOLUTE VALUES | 0 | 2 | 2 | 0 | 0 |
| OF TWO ADJACENT | | | | | |
| DIFFERENCES | | | | | |
| TARGET PATTERN | X | X | X | X | X |
| OUTPUT CIRCUIT | E | E | E | E | E |
| SELECTION (E OR F) | | | | | |
| GRADATION VALUE OF THE | 246 | 246 | 250 | 250 | 250 |
| OUTPUT SIGNAL | | | | | |

The subtraction gradation values that are obtained by subtracting reference gradation value (128) from the pre-conversion gradation value are 123, 123, 125, 125, and 125. Therefore, the sums of absolute values that are calculated by the modulus sum calculation unit 38 are 0, 2, 2, 0, and 0. The target pattern extraction unit 39 therefore determines that the image does not contain a target pattern in which an array of absolute values in the image is “0, 1”, “0, 1, 1”, “0, 1, 1, 1”, and so forth. As a result, the switching circuit 30 outputs the image signal E for all pixels. Thus, smoothing is not carried out for the point of variation at which the gradation difference prior to reverse gamma conversion is two or more.

In this manner, in accordance with the present example, patterns to be smoothed can be detected based on the image signal prior to reverse gamma conversion. Effects other than those described in the present example are the same as those in the first example described above.

What is claimed is:

1. An image signal processing circuit of a display apparatus having a converter circuit for converting inputted image signals and a display device for displaying an image, said image signal processing circuit further comprising:
a smoothing signal generator to which said converted image signals are input and which smoothes the image signal along at least one direction of said image;
a detector for detecting patterns from said image so that a pattern in which the gradation value of a plurality of pixels selected from a plurality of pixels comprising said display device and arrayed in a continuous fashion in said smoothing direction is a first gradation value, the gradation value of another plurality of pixels adjacent to said plurality of pixels on said smoothing direction side and arrayed in a continuous fashion in this direction is a second gradation value, the absolute value of the difference between a first pre-conversion gradation value corresponding to said first gradation value and a second pre-conversion gradation value corresponding to said second gradation value in said pre-conversion image signal is 1, and the absolute value of the difference between said first gradation value and said second gradation value is equal to or greater than 2; and
a substitution unit for substituting said smoothed gradation value in place of the gradation value of at least one pixel selected from the pixels comprising said pattern, and outputting the result to said display device.

2. The image signal processing circuit according to claim 1, wherein
said smoothing signal generator calculates, for each pixel of said display device, the mean gradation value of the gradation values thereof and the gradation values of the pixels positioned on said smoothing direction side of the pixels and the opposite side thereof.

3. The image signal processing circuit according to claim 2, wherein
said smoothing signal generator calculates, for each said pixel, the mean value of three gradation values consisting of the gradation value of the pixel, the gradation value of one pixel adjacent to said smoothing direction side of the pixel, and the gradation value of another pixel adjacent to the opposite side of said smoothing direction side of said pixel; and
the value made into an integer by rounding up the places to the right of the decimal point of the mean value being used as said mean gradation value.

4. The image signal processing circuit according to claim 3, wherein
said detector having:
a difference modulus calculation unit for calculating the absolute value of the difference between said converted gradation value and said mean gradation value for each of said pixels; and
a target pattern extraction unit for extracting patterns comprising a pixel in which the absolute value of the difference between said gradation value and said mean gradation value is 0, and one or a plurality of pixels that are adjacent on the smoothing direction side of the pixel and that have an absolute value of 1; wherein
said substitution unit substitutes said mean gradation value in place of the gradation value of one or a plurality of pixels in which said absolute value is 1.

5. The image signal processing circuit according to claim 4, wherein
said detector has a reference brightness level adjustment unit for outputting to said difference modulus calculation unit a first subtraction gradation value obtained by subtracting a reference gradation value from said converted gradation value, and outputting to said difference modulus calculation unit a second subtraction gradation value obtained by subtracting said reference gradation value from said mean gradation value; and
said difference modulus calculation unit calculates the absolute value of the difference between said first subtraction gradation value and said second subtraction gradation value.

6. The image signal processing circuit according to claim 3, wherein
said detector has:
a modulus sum calculation unit for computing the sum of the absolute value of the difference between the pre-conversion gradation value prior to said conversion of the target pixel and the pre-conversion gradation value of the pixel adjacent on the smoothing direction side of the pixel, and the absolute value of the difference between the pre-conversion gradation value of said target pixel and the pre-conversion gradation value of the pixel adjacent to the pixel on the opposite side in the smoothing direction; and
a target pattern extraction unit for extracting patterns having a pixel in which said sum of absolute values is 0, and further having one or a plurality of pixels that are adjacent on the smoothing direction side of the pixel and that have a sum of absolute values of 1; wherein
the substitution unit substitutes said mean gradation value in place of the gradation value of one or a plurality of pixels in which said sum of absolute values is 1.

7. The image signal processing circuit according to claim 6, wherein
said detector has a reference brightness level adjustment unit for outputting to said modulus sum calculation unit a subtraction gradation value obtained by subtracting a reference gradation value from said pre-conversion gradation value; and
said modulus sum calculation unit calculates said sum of absolute values on the basis of said subtraction gradation value.

8. The image signal processing circuit according to claim 1, wherein
said conversion circuit is a circuit for performing reverse gamma conversion.

9. The image signal processing circuit according to claim 8, wherein
said display device is a plasma display panel.

10. A display apparatus having a converter circuit for converting inputted image signals, an image signal processing circuit for processing said converted image signals, and a display device for displaying an image on the basis of an image signal input from the image signal processing circuit, said image signal processing circuit comprising:
a smoothing signal generator to which said converted image signals are input and which smoothes the image signal along at least one direction of said image;
a detector for detecting patterns from said image so that a pattern in which the gradation value of a plurality of pixels selected from a plurality of pixels comprising said display device and arrayed in a continuous fashion in said smoothing direction is a first gradation value, the gradation value of another plurality of pixels adjacent to said plurality of pixels on said smoothing direction side and arrayed in a continuous fashion in this direction is a second gradation value, the absolute value of the difference between a first pre-conversion gradation value corresponding to said first gradation value and a second pre-conversion gradation value corresponding to said second gradation value in said pre-conversion image signal is 1, and the absolute value of the difference between said first gradation value and said second gradation value is equal to or greater than 2; and
a substitution unit for substituting said smoothed gradation value in place of the gradation value of at least one pixel selected from the pixels comprising said pattern, and outputting the result to said display device.

11. The display apparatus according to claim 10, wherein
said smoothing signal generator calculates, for each pixel of said display device, the mean gradation value of the gradation values thereof and the gradation values of the pixels positioned on said smoothing direction side of the pixels and the opposite side thereof.

12. The display apparatus according to claim 11, wherein
said smoothing signal generator calculates, for each said pixel, the mean value of three gradation values consisting of the gradation value of the pixel, the gradation value of one pixel adjacent to said smoothing direction side of the pixel, and the gradation value of another pixel adjacent to the opposite side of said smoothing direction side of said pixel; and
the value made into an integer by rounding up the places to the right of the decimal point of the mean value being used as said mean gradation value.

13. The display apparatus according to claim 12, wherein
said detector has:
a difference modulus calculation unit for calculating the absolute value of the difference between said converted gradation value and said mean gradation value for each of said pixels; and
a target pattern extraction unit for extracting patterns comprising a pixel in which the absolute value of the difference between said gradation value and said mean gradation value is 0, and one or a plurality of pixels that are adjacent on the smoothing direction side of the pixel and that have an absolute value of 1; wherein
said substitution unit substitutes said mean gradation value in place of the gradation value of one or a plurality of pixels in which said absolute value is 1.

14. The display apparatus according to claim 13, wherein
said detector has a reference brightness level adjustment unit for outputting to said difference modulus calculation unit a first subtraction gradation value obtained by subtracting a reference gradation value from said converted gradation value, and outputting to said difference modulus calculation unit a second subtraction gradation value obtained by subtracting said reference gradation value from said mean gradation value; and
said difference modulus calculation unit calculates the absolute value of the difference between said first subtraction gradation value and said second subtraction gradation value.

15. The display apparatus according to claim 12, wherein
said detector has:
a modulus sum calculation unit for computing the sum of the absolute value of the difference between the pre-conversion gradation value prior to said conversion of the target pixel and the pre-conversion gradation value of the pixel adjacent on the smoothing direction side of the pixel, and the absolute value of the difference between the pre-conversion gradation value of said target pixel and the pre-conversion gradation value of the pixel adjacent to the pixel on the opposite side in the smoothing direction; and
a target pattern extraction unit for extracting patterns having a pixel in which said sum of absolute values is 0, and further having one or a plurality of pixels that are adjacent on the smoothing direction side of the pixel and that have a sum of absolute values of 1, wherein
the substitution unit substitutes said mean gradation value in place of the gradation value of one or a plurality of pixels in which said sum of absolute values is 1.

16. The display apparatus according to claim 15, wherein
said detector has a reference brightness level adjustment unit for outputting to said modulus sum calculation unit a subtraction gradation value obtained by subtracting a reference gradation value from said pre-conversion gradation value; and
said modulus sum calculation unit calculates said sum of absolute values on the basis of said subtraction gradation value.

17. The display apparatus according to claim 10, wherein:
said conversion circuit is a circuit that performs reverse gamma conversion.

18. The image signal processing circuit according to claim 17, wherein
said display device is a plasma display panel.

19. An image signal processing method, comprising:
generating a smoothing signal for smoothing a converted image signal along at least one direction of the image;
detecting patterns from said image so that a pattern in which the gradation value of a plurality of pixels selected from a plurality of pixels comprising said display device and arrayed in a continuous fashion in said smoothing direction is a first gradation value, the gradation value of another plurality of pixels adjacent to said plurality of pixels on said smoothing direction side and arrayed in a continuous fashion in this direction is a second gradation value, the absolute value of the difference between a first pre-conversion gradation value corresponding to said first gradation value and a second pre-conversion gradation value corresponding to said second gradation value in said pre-conversion image signal is 1, and the absolute value of the difference between said first gradation value and said second gradation value is equal to or greater than 2; and
substituting said smoothed gradation value in place of the gradation value of at least one pixel selected from the pixels comprising said pattern.
